(19) United States
(12) Patent Application Publication
(10) Pub. No.: US 2010/0091400 A1
(43) Pub. Date: Apr. 15, 2010

(54) MAGNETIC DISK APPARATUS AND SLIDER FOR MAGNETIC RECORDING

(75) Inventor: Shingo Hamaguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/555,258

(22) Filed: Sep. 8, 2009

(30) Foreign Application Priority Data
Oct. 10, 2008 (JP) 2008-264441

(51) Int. Cl. G11B 21/02

(52) U.S. Cl. 360/75; G9B/21.003

(57) ABSTRACT

According to one embodiment, a magnetic disk apparatus includes a patterned disk, a slider, two read heads, a write head, and a drive circuit. The patterned disk has a magnetic recording surface on which bit patterns are arranged concentrically. The slider is located near the magnetic recording surface, and moves relatively to the magnetic recording surface. The read heads are arranged along a medium running direction at an end of the slider, and read magnetic data from the magnetic recording surface. The write head is located between the read heads, and records magnetic data to the bit patterns. The drive circuit drives the write head at a timing based on a period from when one of the read heads located upstream in the medium running direction reads magnetic data until the other located downstream reads the magnetic data at the same position on the magnetic recording surface.

### CROSS-REFERENCE TO RELATED APPLICATIONS

This application is based upon and claims the benefit of priority from Japanese Patent Application No. 2008-264441, filed Oct. 10, 2008, the entire contents of which are incorporated herein by reference.

### BACKGROUND

1. Field

One embodiment of the invention relates to a magnetic disk apparatus with a patterned disk.

2. Description of the Related Art

As a storage medium provided to a magnetic disk apparatus called a hard disk drive (HDD), a patterned disk attracts attention. The patterned disk as used herein refers to a bit-patterned medium of which data storage regions are structurally patterned. The recording track of such a patterned disk has an independent magnetic pattern by bit. The bit-patterned medium improves the magnetic recording density because information recorded thereon hardly changes.

However, to record data on a bit-patterned disk, it is necessary to synchronize the drive of a write head for recording with the relative movement of a bit pattern due to the rotation of the disk. In other words, a recording magnetic field needs to be generated when the write head faces a bit pattern to be recorded among bit patterns arranged discretely. Regarding this synchronization, there has been proposed a conventional technology in which a sensor for detecting magnetic patterns is provided to a slider having a write head and a read head for reading data and the recording timing is controlled based on the output of the sensor (see U.S. Pat. No. 6,754,017B2).

FIG. 9 is a diagram of an arrangement of heads for conventional recording timing control. A write head W, a read head R, and a magnetic pattern sensor PS face a patterned disk 3 while being supported by a slider (not illustrated). The patterned disk 3 moves in a medium running direction (trailing direction) indicated by an arrow M2. The read head R is located upstream (leading side) of the write head W in the medium running direction, and the magnetic pattern sensor PS is located further upstream thereof. The distances between the write head W, the read head R, and the magnetic pattern sensor PS, produced by a thin film technique, are known.

To record data into a bit pattern on the patterned disk 3 with the head write W, the magnetic pattern sensor PS detects the bit pattern, and the write head W outputs the data after a predetermined time has elapsed since the detection time point. The predetermined time is the time required for the bit pattern to move from the position facing the magnetic pattern sensor PS to the position facing the write head W. This time is obtained by calculation.

The value to be obtained is time Ty from when the magnetic pattern sensor PS faces a point on the recording track to when the write head W faces the point. Measurable time Tx is the time from when the magnetic pattern sensor PS faces a point on the recording track to when the read head R faces the point. The rotation speed S of the patterned disk 3 is constant while the time Tx is measured and the write head W records the data based on the measurement result.

The time Ty is represented by the following equation:

Ty=Tx×(Y/X)

where X is the distance between the magnetic pattern sensor PS and the read head R, Y is the distance between the magnetic pattern sensor PS and the write head W, and D is the distance between the read head R and the write head W. The ratio (Y/X) of the distance X to the distance Y is known.

To improve the accuracy of the recording timing control to a bit-patterned disk, it is necessary to consider thermal expansion of the head. The temperature of the write head W and its vicinity are changed by the heat when the current is applied. In other words, the distances D, X, and Y are not constant, strictly speaking. The thermal expansion coefficient between the magnetic pattern sensor PS and the write head W is usually different from that between the write head W and the read head R. Therefore, the ratio (Y/X) of the distance X to the distance Y is not constant.

It is assumed that, at the measurement of the time Tx regarding the distance X, the distances X and D become αX and βD by thermal expansion, respectively. In this case, because the measured time Tx is αX/S, time Ty′ calculated by using the above equation is represented as follows:

$$\begin{matrix}{Ty}^{′} = Tx \times ( Y / X ) \\ = ( α X / S ) \times ( Y / X ) \\ = α Y / S\end{matrix}$$

However, the time Ty that is supposed to be calculated is: Ty=(αX+βD)/S.

Therefore, the error, ΔTy=Ty′−Ty, in the calculation result is represented as follows:

$$\begin{matrix}Δ Ty = α Y / S - ( α X + β D ) / S \\ = [ α ( X + D ) - ( α X + β D ) ] / S \\ = ( α - β ) D / S\end{matrix}$$

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an arrangement of heads for recoding timing control according to an embodiment of the invention;

FIG. 2 is an exemplary diagram of an arrangement of a write head and read heads on a slider in the embodiment;

FIG. 3 is an exemplary diagram of a configuration of a magnetic disk apparatus in the embodiment;

FIG. 4 is an exemplary diagram for explaining region division of a disk surface on a patterned disk in the embodiment;

FIG. 5 is an exemplary diagram of a structure of a user data region and a servo region in the embodiment;

FIG. 6 is an exemplary diagram of an arrangement of bit patterns in the embodiment;

FIG. 7 is an exemplary schematic flowchart of a recording operation in the embodiment;

FIG. 8 is an exemplary sectional view of a layer structure of the read heads and the write head in the embodiment; and

FIG. 9 is an exemplary diagram of an arrangement of heads for conventional recording timing control.

### DETAILED DESCRIPTION

Various embodiments according to the invention will be described hereinafter with reference to the accompanying drawings. In general, according to one embodiment of the invention, a magnetic disk apparatus records and replays magnetic data by rotating a storage medium, and comprises a patterned disk, a slider, two read heads, a write head, and a drive circuit. The patterned disk, as the storage medium, is configured to have a magnetic recording surface on which a plurality of bit patterns are arranged concentrically. The slider, near the magnetic recording surface, is configured to move relatively to the magnetic recording surface. The read heads are arranged along a medium running direction at an end of the slider, and are configured to read magnetic data from the magnetic recording surface. The write head is located between the read heads, and is configured to record magnetic data to the bit patterns. The drive circuit is configured to drive the write head at a timing based on a period from when, of the read heads, a read head located upstream in the medium running direction reads magnetic data until a read head located downstream reads the magnetic data at the same position on the magnetic recording surface.

According to another embodiment of the invention, a slider for magnetic recording to a bit pattern of a patterned disk comprises two read heads and a write head. The read heads are arranged along a medium running direction upon recording at an end on an air outflow end side, and are configured to read magnetic data recorded on the patterned disk. The write head is located between the read heads, and is configured to record magnetic data to the bit pattern.

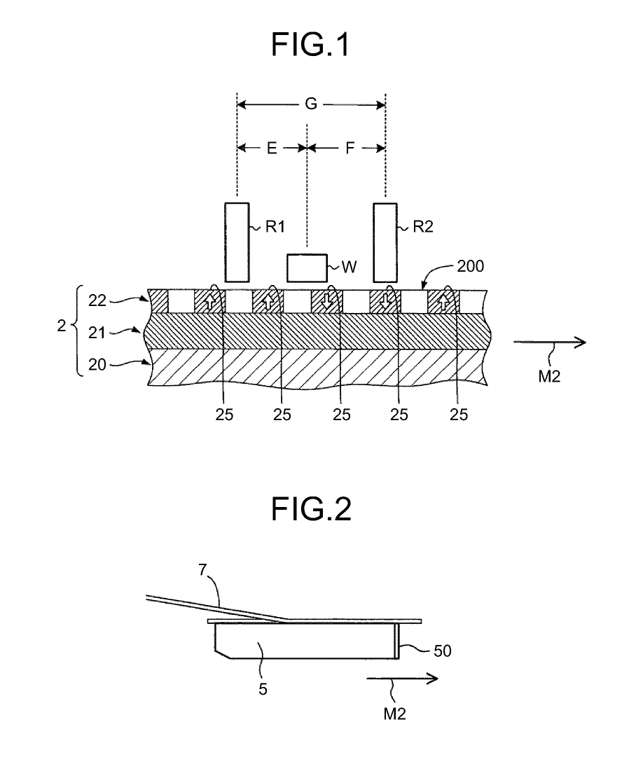

The magnetic disk apparatus according to an embodiment of the invention comprises a write head and two read heads. As schematically illustrated in FIG. 1, the write head W and the two read heads R1 and R2 face a magnetic recording surface 200 of a patterned disk 2 that relatively moves in a medium running direction indicated by an arrow M2. The patterned disk 2 has a soft magnetic backing layer 21 and a magnetic recording layer 22 that are stacked on a substrate 20 made of, for example, glass, metal, or resin. The magnetic recording layer 22 has a portion made of a magnetic body that corresponds to bit patterns 25 and a portion made of a non-magnetic body that separates the bit patterns 25. First, the read head R1 on the leading side, which is upstream in the medium running direction M2, faces each bit pattern 25 on the rotating magnetic recording surface 200, then the write head W faces the bit pattern 25, and thereafter the read head R2 on the trailing side, which is downstream in the medium running direction M2, faces the bit pattern 25. The term “on the leading side” as used herein means that the position of the object to be interested is comparatively closer to a front edge (an air inflow end of a glide surface) of a slider than the positions of other objects to be compared when these three heads are integrally supported by the slider and relatively move along a recording track. The term “on the trailing side” means the opposite of “on the leading side”, i.e., the position of the object to be interested is comparatively farther from the front edge of the slider than the positions of the other objects. In FIG. 1, the leading side is on the left side and the trailing side is on the right side.

The salient future is the order of the three heads in which the write head W is located between the two read heads R1 and R2. This arrangement of the three heads reduces errors in the recording timing control as described below.

To record data to the bit patterns 25 of the patterned disk 2 with the write head W, the read head R1 detects the bit patterns 25 and the write head W outputs the data at the time after a predetermined time has elapsed since the detection time point. The predetermined time is the time required for the bit pattern 25 to which the data is to be recorded to move from the position facing the read head R1 to the position facing the write head W. This time is obtained by calculation.

The value to be obtained is time Te from when the read head R1 on the leading side faces a point on the magnetic recording surface 200 to when the write head W faces the point. Measurable time Tg is the time from when the read head R1 on the leading side faces a point on the magnetic recording surface 200 to when the read head R2 on the trailing side faces the point. Note that the rotation speed S of the patterned disk 2 is assumed constant while the time Tg is measured and the write head W is driven to record at the timing reflecting the measurement result. In the measurement of the time Tg, instead of detecting the minimal bit patterns 25, preferably, patterns for servo control elongate in a radial direction of the disk, which can be detected more reliably, are detected.

At normal temperature, the time Te is represented as follows:

$$\begin{matrix}Te = Tg \times ( E / G ) \\ = ( G / S ) \times ( E / G ) \\ = E / S\end{matrix}$$

where G is the distance between the read head R1 on the leading side and the read head R2 on the trailing side, E is the distance between the read head R1 on the leading side and the write head W, and F is the distance between the write head W and the read head R2 on the trailing side. The ratio (E/G) of the distance G to the distance E at normal temperature is known.

Here, it is assumed that the distance E becomes aE and the distance F becomes bF by thermal expansion at the measurement of the time Tg. In this case, the measured time Tg is (aE+bF)/S, whereby the time Te′ to be calculated is represented as follows:

$$\begin{matrix}{Te}^{′} = \{ ( aE + bF ) / S \} \times ( E / G ) \\ = ( aE + aF - aF + bF ) \times ( E / G ) / S \\ = \{ a ( E + F ) - ( a - b ) F \} \times ( E / G ) / S \\ = \{ aG - ( a - b ) F \} \times ( E / G ) / S \\ = \{ aE - ( a - b ) F \times ( E / G ) \} / S\end{matrix}$$

However, the time Te that is supposed to be calculated is Te=aE/S. Therefore, the error ΔTe in the result of the calculation is represented as follows:

$$\begin{matrix}Δ Te = {Te}^{′} - Te \\ = \{ aE - ( a - b ) F \times ( E / G ) \} / S - aE / S \\ = - ( a - b ) \times ( E / G ) \times F / S\end{matrix}$$

Because 0<E/G<1, even if the thermal expansion coefficients between each of the two read heads R1, R2 and the write head W are different, the absolute value of the error ΔTe is smaller than the product of the difference (a−b) of the thermal expansion coefficients, the distance F, and the speed S. If the structure of a multi-layered body constituting the heads is similar to the conventional structure, the difference (a−b) of the thermal expansion coefficients is not significantly different from the difference (α−β) of the thermal expansion coefficients between heads in the conventional structure illustrated in FIG. 9. Assuming that the difference (a−b) of the thermal expansion coefficients according to the embodiment is nearly equal to the difference (α−β) of the thermal expansion coefficients according to the conventional example and the distance F is substantially equal to the distance D of the conventional structure, the error ΔTe according to the embodiment is smaller than the error ΔTy=(α−β) D/S according to the conventional structure. In other words, the error ΔTe is (E/G) times larger than the error ΔTy and smaller than the error ΔTy. If the distances E and F are set as the same value or close values, the error ΔTe is approximately half the error ΔTy. If the difference (a−b) of the thermal expansion coefficients according to the embodiment is different from the difference (α−β) of the thermal expansion coefficients according to the conventional example, the error ΔTe can be smaller than the error ΔTy according to the conventional structure by appropriately setting the ratio (E/G) of the distances.

In addition, in the head arrangement of the embodiment, the error ΔTe is likely to be substantially zero. Unlike the case where read heads are arranged on one side of the write head, the read heads R1 and R2 are arranged on both sides of the write head W serving as the main heat source. Accordingly, the temperature distribution between the write head W and the read head R1 is similar to that between the write head W and the read head R2. If the thermal expansion coefficient a regarding the distance E is substantially equal to the thermal expansion coefficient b regarding the distance F, the error ΔTe is substantially zero. To make the error ΔTe zero, the write head W is preferably arranged at the center between the read heads R1 and R2. Moreover, the read heads R1 and R2 are preferably formed in symmetry about the write head W.

The read heads R1, R2, and the write head W are produced by using a known thin film technique and is included in a multi-layered body 50. The multi-layered body 50 is fixed to the end on the air outflow end side (trailing side) of a slider 5 as illustrated in FIG. 2. The slider 5 supported by a head gimbal assembly 7 is produced by dividing and processing a wafer on which the multi-layered body 50 is formed.

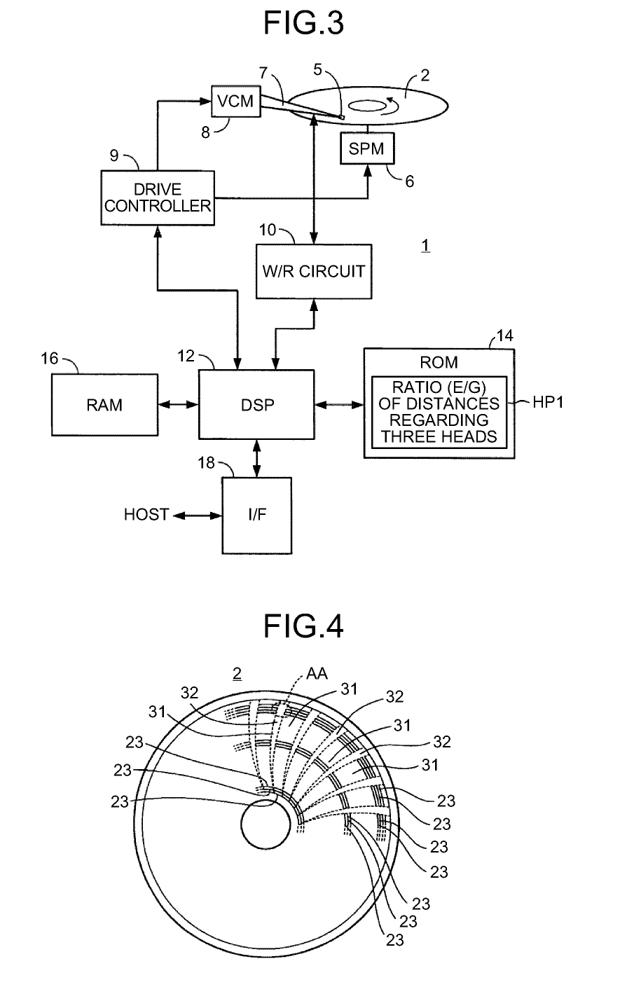

FIG. 3 is a diagram of a configuration of the magnetic disk apparatus according to the embodiment.

A magnetic disk apparatus 1 is a storage including one or more patterned disk 2 as a storage medium, and records/replays bit data strings, similarly to known hard disk drives, by relatively moving the patterned disk 2 and the heads supported by the slider 5. A drive controller 9 controls a spindle motor (SPM) 6 and a voice coil motor (VCM) 8. The SPM 6 rotates the patterned disk 2. The VCM 8 moves the slider 5 in a radial direction of the disk. A write signal is given to the write head on the slider 5 from a write/read circuit (W/R circuit) 10 including a head amplifier. A read signal from each of the two read heads is sent to the W/R circuit 10. The W/R circuit 10 performs encoding, based on the writing data given by a digital signal processor (DSP) 12, to generate encoded data to be recorded on the patterned disk 2. The W/R circuit 10 also performs signal processing to decode signals read from the patterned disk 2 and outputs the decoded signals to the DSP 12. The DSP 12 transmits and receives data to and from a host as an external apparatus via an interface (I/F) 18. The DSP 12 also notifies the drive controller 9 of the access position to the patterned disk 2. The interface 18 has a buffer for adjusting timing of data transmission and reception.

The magnetic disk apparatus 1 further comprises a read only memory (ROM) 14 that stores therein programs to be executed by the DSP 12 and a random access memory (RAM) 16 that serves as a work area for executing the programs. The ROM 14 previously stores therein data HP1 indicating the ratio (E/G) of the distance G to the distance E relating to the three heads. The data HP1 is transferred to the RAM 16 immediately after the activation, and used for calculation of the time Te performed by the DSP 12 during subsequent recording. The data HP1 may be recorded on the patterned disk 2 in advance.

In the measurement of the time Tg for obtaining the time Te, the two read heads R1 and R2 detect magnetic patterns in servo regions 32 defined on the patterned disk 2 as illustrated in FIG. 4. In FIG. 4, an circular disk surface of the patterned disk 2 is divided into a plurality of user data regions 31 and a plurality of the servo regions 32 along the circumferential direction in such a manner as to, for example, divide the circle by a predetermined angle. The user data regions 31 and the servo regions 32 are alternately arranged in the circumferential direction. Recording tracks 23 are provided concentrically at a certain pitch in the radial direction in the user data regions 31. In the servo regions 32 is provided a servo pattern that is a magnetic pattern for servo control. The region setting illustrated in FIG. 4 is adapted to an access in the state of rotating at a constant angular velocity (CAV) and a seeking operation performed by a rotary arm. Therefore, the user data regions 31 and the servo regions 32 get wider toward the outer periphery, and have curved shapes along a movement path of the tip of the arm.

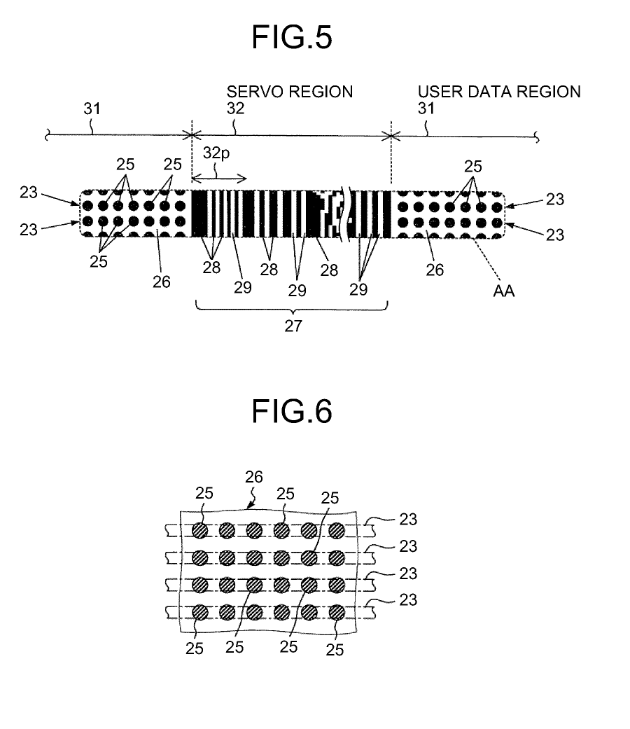

FIG. 5 is an enlarged view of a portion AA enclosed by a broken line in FIG. 4 illustrating a schematic structure of the user data regions 31 and the servo region 32.

Each user data region 31 has many bit patterns 25 (black portions in FIG. 5) that are regions for recording data by bit unit, and a separation region 26 (white portion in FIG. 5) that magnetically isolates the bit patterns 25. In FIG. 5, although only some of the bit patterns 25 are designated by a numeral, all the black circles represent the bit patterns 25. Among the bit patterns 25 arranged in the circumferential direction (horizontal direction in FIG. 5) and the radial direction (vertical direction in FIG. 5), one row of the bit patterns 25 along the circumferential direction corresponds to one recording track 23 (see FIG. 6). Each bit pattern 25 has a round shape and a diameter of about 10 nanometers. The arranged pitch of the bit patterns 25 in each recording track 23 is about 15 to 20 nanometers, and the arranged pitch of the recording tracks 23 is also about 15 to 20 nanometers.

The servo region 32 has a servo pattern 27. The servo pattern 27 is an arrangement pattern including magnetic portions 28 (black portions in FIG. 5) and non-magnetic portions 29 (white portions in FIG. 5). The magnetic portions 28 have the same layer structure as the bit patterns 25, and the non-magnetic portions 29 have the same layer structure as the separation region 26. The servo pattern 27 includes a preamble pattern formed on a preamble portion 32p in the servo region 32, a burst pattern for tracking, and a gray code pattern for representing address information. The preamble pattern is formed into a long band from the inner edge to the outer edge of the magnetic recording surface along the radial direction of the disk so that the preamble pattern is detectable even if the read heads R1 and R2 are off-track.

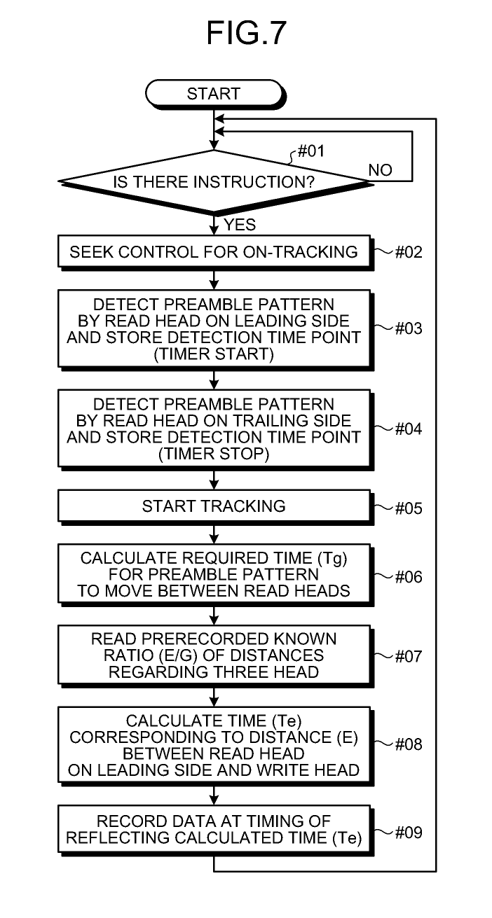

FIG. 7 is a flowchart of the recording operation performed by the magnetic disk apparatus 1.

Once receiving an access instruction from the host, the DSP 12 notifies the drive controller 9 of the number of an access start track and a sector (#01). The drive controller 9 performs seek control to track on the recording track 23 to be accessed (#02). The DSP 12 detects a preamble pattern in the servo region 32 based on the output of the read head R1 on the leading side, and stores the detection time point (#03). The operation “store” at #03 may indicate to start a timer. The DSP 12 then detects a preamble pattern based on the output of the read head R2 on the trailing side and stores the detection time point (#04). The operation “store” at #04 may indicate to stop the timer which is counting the time. After both the read heads R1 and R2 detect the preamble pattern, the drive controller 9 starts tracking (#05).

In parallel to the tracking, the DSP 12 calculates the time Tg required for the preamble pattern to move between the read heads based on the two detection time points stored therein. When the time Tg is measured by the timer, the DSP 12 obtains the result of the measurement time (#06). The DSP 12 then reads the data HP1 indicating the ratio (E/G) of the distance G to the distance E transferred from the RAM 16 in advance (#07), and calculates the time Te corresponding to the distance E between the read head R1 on the leading side and the write head W (#08). The calculated time Te is given to the W/R circuit 10 as timing correction information.

The W/R circuit 10 drives the write head W according to the bit string to be recorded. At this time, to effectively exert a recording magnetic field on the bit patterns 25, a current is applied to the write head W at the timing of reflecting the time Te (#09). More specifically, while the read head R1 on the leading side detects one row of the bit patterns 25, a recording magnetic field in the direction according to the bit value is generated at a timing delayed by the time Te from the detection time point of each bit pattern 25.

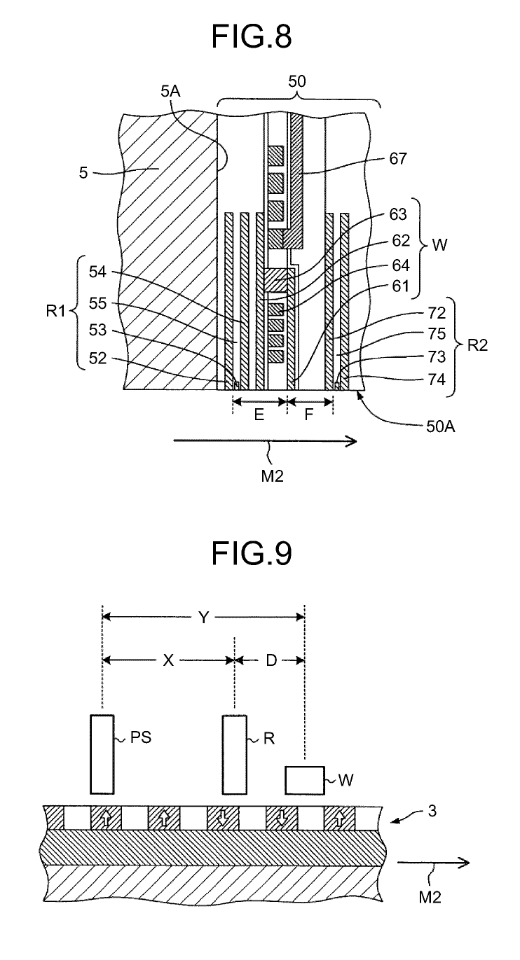

For the calculation of the time Te in such a recording operation, accuracy of the ratio (E/G) of the distance G to the distance E indicated by the data HP1 is required. The values of the distances E and G need not necessarily be known to specify the value of the ratio. The ratio (E/G) can be calculated by using the film formation rate and time of each layer regarding the distance G and the film formation rate and time of each layer regarding the distance E in the production of the multi-layered body 50 including the two heads. In other words, the read head R1, the write head W, and the read head R2 are sequentially produced by a series of thin film processes, whereby the ratio (E/G) can be specified without measuring the distances E and G. FIG. 8 illustrates an example of the layer structure of the multi-layered body 50.

In FIG. 8, the multi-layered body 50 fixed to an end 5A of the slider 5 has the Tunnel Magneto-Resistive (TMR) or Giant Magneto-Resistive (GMR) read head R1, the single magnetic pole type write head W, and the read head R2 having the same structure as that of the read head R1. The write head W is placed on the read head R1 with an insulator therebetween. The read head R2 is placed on the write head W with an insulator therebetween. The multi-layered body 50 is produced by a combination of film formation by sputtering or plating, layer processing by electron beam lithography and ion milling, and flattening by chemical mechanical polishing.

The read head R1 comprises a lower shield 52 made of a soft magnetic body such as Ni80Fe20, a read element 53 having a width corresponding to the recording tracks, an upper shield 54 made of the same material as that of the lower shield 52, and an alumina layer 55 magnetically dividing them. As with the read head R1, the read head R2 comprises a lower shield 72, a read element 73, an upper shield 74, and an alumina layer 75.

The write head W comprises a main magnetic pole 61 made of Fe70Co30 or a magnetic body, a return yoke 62 made of a soft magnetic body, a return yoke connecting module 63 connecting the main magnetic pole 61 to the return yoke 62, and a patterned thin film coil 64 surrounding the return yoke connecting module 63. The material Fe70Co30 or Ni90Al10 may be used for the main magnetic pole 61. Besides, Ni80Fe20 may be cited as an example of the material used for the return yoke 62 and the return yoke connecting module 63. The thin film coil 64 and a lead line 67 connected to the thin film coil 64 are made of, for example, copper (Cu). In the example of FIG. 8, the main magnetic pole 61 is arranged on the trailing side of the return yoke 62; however, it is also possible to invert the order in which layers of the write head W are stacked so that the main magnetic pole 61 locates on the leading side of the return yoke 62.

As illustrated in FIG. 8, the distance E between the read head R1 and the write head W is, strictly speaking, the length from the leading side edge of the read element 53 to the leading side edge of the main magnetic pole 61 on an end 50A on the disk side of the multi-layered body 50. The distance F between the write head W and the read head R2 is, strictly speaking, the length from the leading side edge of the main magnetic pole 61 to the leading side edge of the read element 73 on the end 50A.

In the embodiment, it is possible to change the structure of the magnetic disk apparatus 1 including the layer structures of the read heads R1, R2, and the write head W.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk apparatus that records and replays magnetic data by rotating a storage medium, the magnetic disk apparatus comprising:
a patterned disk as the storage medium configured to have a magnetic recording surface on which a plurality of bit patterns are arranged concentrically;
a slider near the magnetic recording surface, the slider configured to move relatively to the magnetic recording surface;
two read heads arranged along a medium running direction at an end of the slider, the read heads configured to read magnetic data from the magnetic recording surface;
a write head between the read heads, the write head configured to record magnetic data to the bit patterns; and
a drive circuit configured to drive the write head at a timing based on a period from when, of the read heads, a read head located upstream in the medium running direction reads magnetic data until a read head located downstream reads the magnetic data at a same position on the magnetic recording surface.

2. The magnetic disk apparatus of claim 1, wherein
the read head located upstream, the write head, and the read head located downstream each configured to include a plurality of thin films in layers, and
the write head is configured to be located at substantially center between the read heads.

3. The magnetic disk apparatus of claim 2, wherein the read head located upstream and the read head located downstream have an identical layer structure.

4. A slider for magnetic recording to a bit pattern of a patterned disk, the slider comprising:
two read heads arranged along a medium running direction upon recording at an end on an air outflow end side, the read heads configured to read magnetic data recorded on the patterned disk; and
a write head between the read heads, the write head configured to record magnetic data to the bit pattern.

5. The slider of claim 4, wherein
the read heads includes an upstream read head located upstream and a downstream read head located downstream,
the upstream read head, the write head, and the downstream read head each comprises a plurality of thin films in layers, and
the write head is configured to be located at substantially center between the read heads.

6. The slider of claim 5, wherein the upstream read head and the downstream read head are identical in layer structure.
